(19) United States
(12) Patent Application Publication
(10) Pub. No.: US 2018/0365600 A1
(43) Pub. Date: Dec. 20, 2018

(54) SYSTEMS AND METHODS FOR VIRTUAL QUEUING

(71) Applicant: SeaWorld Parks & Entertainment, Inc., Orlando, FL (US)

(72) Inventors: TIM CARRIER, CLERMONT, FL (US); BRIAN MISHLER, OCOEE, FL (US); SEAN WILLIAMS, ORLANDO, FL (US); BRYAN NADEAU, WINTER GARDEN, FL (US); DAVID HEATON, WINTER GARDEN, FL (US)

(21) Appl. No.: 16/012,439

(22) Filed: Jun. 19, 2018

Related U.S. Application Data
(60) Provisional application No. 62/521,892, filed on Jun. 19, 2017.

(51) Int. Cl. G06Q 10/02

(52) U.S. Cl. CPC G06Q 10/02

(57) ABSTRACT

A virtual queue system which utilizes a default first-in-first-out (FIFO) system but can modify the FIFO nature of the system to allow for adjustment of place in line based on desire to experience a second attraction while in the virtual queue for the primary attraction. This will usually result in the voluntary acceptance of a later line position in exchange for knowledge that the waiting time is sufficient to experience the secondary attraction.

### CROSS REFERENCE TO RELATED APPLICATION(S)

This Application claims the benefit of U.S. Provisional Patent Application Ser. No. 62/521,892, filed Jun. 19, 2017 and currently pending, the entire disclosure of which is incorporated herein by reference.

### BACKGROUND

### 1. Field of the Invention

This disclosure relates to the field of systems and methods for queuing and specifically for the queuing of patrons to enter a primary attraction where the queue position can be modified to allow the patron to go to an additional attraction while waiting for the first.

### 2. Description of the Related Art

There are a large number of instances in every person's life where they need to wait for something. In many cases, they are not waiting alone, but are waiting with a number of other people that are also waiting for the same thing. When a number of people are waiting for the same activity, they will commonly form lines or queues where they arrange themselves to stand in their order of arrival. This is often done as a social norm and has been theorized as simply an understanding of accepted behavior (in countries where the behavior is exhibited) that those that arrive first to an activity should be treated to the activity first. That is, much of the world commonly feels that first-in-first-out (FIFO) arrangements are the most fair.

As much as queues may be a common part of life, most people find standing in them particularly unpleasant. Specifically, people are bored when they are waiting in queues and will often overestimate the amount of time they have been in a queue. This is commonly caused because an individual in a queue is idle and when an individual is unoccupied, they often perceive time as moving slower. Because of these problems, a whole area of queue management has arisen which allows a business owner to monitor their queues and better react to them before customers get irritated by their length and may leave or not return.

Many types of businesses have to deal with the problems of queues and making them a better experience for customers. In retail stores, businesses often deal with queues by trying to make them shorter. Often, a retail environment will have many more checkout lanes than are actually needed at most times. To shorten queue length, once the queues hit a certain length on the open lanes, the store will open additional lanes to shorten the queues and keep the wait times down. Retail business will also often give a customer something to do in the queue, such as unloading product onto a conveyor belt or reading the latest tabloid newspapers that are displayed by the queue positions. In other environments, queues can be broken up to provide that a customer stand in multiple shorter queues instead of one long one. For example, an order may be processed while in a first queue, a second queue is used to pay, and a third queue is used to pick up the purchase at the end.

While these systems can be quite effective in retail, other businesses cannot use them. In many cases it is simply not possible to have multiple queues to certain activities because the activities are non-substitutable and cannot be readily divided. One example is a doctor's waiting room. There is only one doctor and, therefore, additional queues cannot be opened if the wait gets to be too long. Even if there is a second doctor available, the patient may be specific to one or the other and they cannot be moved to whichever doctor has the shorter wait.

Other businesses that can have trouble with queues are amusement parks and other similar entertainment venues. In these types of venues, rides and shows within a park are commonly unique and not readily duplicated due to both size and expense. Further, the capacity of virtually all rides and shows is generally very limited compared to the capacity of the park. The length of time that the ride or show will last is also generally fixed. Therefore, these types of attractions have a certain maximum throughput which is often well below the number of patrons that wish to experience them in peak hours.

While good ride and show design can keep queues moving quickly, even at peak hours, long queues are often the noun at entertainment and amusement park venues. For certain rides, it would not be surprising to spend 20-30 times the length of the ride, or more, in line waiting for it. Because amusement parks can often not avoid long lines, particularly on very popular and new attractions, amusement parks often attempt to keep the people in line from being idle as an alternative solution to help them tolerate the waiting.

In a first instance, the queueing areas are often arranged so the space for queues is quite long compared to the normal expected queue for the attraction. This both allows for differing capacity at different times, but gives the individual something to do (walk along the queue path) and makes the patron feel like the queue is shorter than it actually is. Many queue pathways are also decorated or include exhibits or other entertainment that can be experienced in line. These secondary attractions serve to keep people standing in the queue from being unoccupied. Queue lines can include videos to watch, games to play, or even other interactive attractions to try to keep the idleness of patrons in the queue down.

While these types of solutions can be fairly effective, they have problems of their own. In the first instance, the queue entertainment is often repetitive and runs on a circular pattern or something similar. Thus, while an individual in the queue may enjoy watching the introduction video the first time they see it, by the fifth time the patron sees the same video loop, it often does not serve as a distraction, but as a reminder of how slow the queue is moving. Another problem with these queue systems is that they require a large amount of infrastructure which is not a part of the primary ride or attraction. Basically, the attraction is two attractions. The queue entertainment, and the attraction itself. For a patron only interested in the primary attraction, the queue attraction may not provide much distraction and can be expensive to build and maintain. It is also only generally interesting once, while the primary attraction may be of interest multiple times.

While the above are coping strategies for dealing with queues, it has long been recognized that the ideal queue is not to have one. Patrons love rides where they can get off the ride, turn around and walk right back on again, or immediately go and get on another ride. This type of scenario creates happy patrons that want to come back. It also provides more time for patrons to interact with value-add elements of a park. For example, a patron that is not waiting in line or rushing between lines is more likely to visit a food or retail stand and make a purchase. At the same time, amusement park attractions are typically enormously expensive to construct and it is necessary for a park to have more patrons than any single ride can generally accommodate during peak hours to keep the park functioning.

To deal with the problems of physical queues, there have been prior proposals to develop virtual queues and other systems that allow for a large number of patrons to be accommodated on an attraction, without them having to stand in a physical queue. Basically, these systems try to replace the need to stand in a physical line where your movement and options is severely constrained, with a system that keeps the “line” but allows patrons to move around while in it.

Prior virtual queueing systems can commonly be broken into two categories. The first systems are not really virtual queueing systems, but instead they are queue bypass systems. The most well known of these in amusement parks is likely the Fastpass™ which is available at Disney™ parks. The Fastpass™ system does not really provide a place in a virtual queue, but instead provides a reservation time to bypass the queue totally. A patron with a preset reservation time is allowed to jump the physical queue completely and move to the head of the queue or to, at least, join to a much shorter “preferred” access queue.

While reservation systems can be effective, they are not really a FIFO arrangement and, therefore, not really a virtual queue. The patron with the reservation is provided with “prioritized” access to simply avoid the queue. They are not waiting in a virtual line, but get a time which specifically avoids the line completely. Fastpass™ passes are often given to preferred guests, such as those that are staying at a Disney™ owned hotel, and generally have no connection to when a patron arrives at the park or the attraction to join the queue. They can often be reserved many months in advance as they are for a specific ride at a specific time regardless of how many people are in queue for that attraction prior to or at that time. These types of systems are therefore more similar to preferred boarding at airlines which reward those who spend more money on the airline with boarding earlier or reservations at restaurants where the reservation is made to arrive at a specific time regardless of the number of walk-ins waiting. Thus, while the systems allow for some patrons to bypass the queue, they are not virtual queues, but reservation systems which avoid a true FIFO arrangement.

Reservation style systems can provide for benefits with regards to queueing at a macro level. In the first instance, because the reservation is for a specific time in the future, the patron can choose to spend the time prior to the reservation doing anything they want. Specifically, because the patron knows when they need to arrive at the attraction to bypass the queue, the patron can spend the intervening time doing anything anywhere. The downside of reservation systems is that they are inherently not FIFO systems and therefore can feel unfair to those without good access to them. Standing in the line and watching a large group of reservation individuals go ahead of you (particularly if it happens repeatedly) can lead to the same frustration as watching the neighboring lane of traffic move when you are sitting still, or watching the neighboring checkout lane move faster. As such, these types of systems can improve the queue experience for some people and potentially even a majority of people, but do not necessarily assist with queueing issues for everyone and those whose is experience is not improved will often find it worsened.

The second category of virtual queue systems are systems that try to preserve the FIFO nature of the queue, but simply eliminate the physical queue. Restaurant seating systems which utilize a call back buzzer are a simple example of this, as are “take-a-number” systems many people are familiar with at a supermarket deli counter. These types of systems can have the advantage of concealing the queue's size, and also allow a user to move around on their own while waiting which means that they are not forced into idleness by standing in a physical queue. Basically, these types of systems attempt to eliminate the appearance of a queue by eliminating the actual “line” and the need to stand in a fixed position relative to others, but they still maintain the FIFO organization at which patrons arrive by simply storing the order elsewhere. As such, they have eliminated the “line” while still maintaining that people are “in line”.

The problem with these types of virtual systems is that the ability of patrons to move around while waiting is actually severely constrained. While these systems try to allow for increased options during the waiting period, the options are often constrained by the need to return to the line when the patron is at the front. Pagers often only have a limited range and even should the range be long, people can be reluctant to do an activity that may require a fixed time of participation while waiting since they do not know when the pager will activate. The problem is particularly exaggerated because the patrons in these situations do not know the length of the queue. Thus, they may not take part in another activity that only takes fifteen minutes even though their expected wait is half-an-hour because they simply do not know if they will be done with the alternative activity in time to get back to the front (or head) of the line when they need to be there.

These systems are sometimes implemented by providing a virtual queue that utilizes assigning a reservation time which is determined based on the queue length at the time the reservation is made. Thus, when a patron joins the queue, they are placed in the virtual queue and assigned a return time that is when they would need to return and be at the front based on the expected time it will take to process all of the virtual queue in front of them. While they are “in line”, they can then do something else safe in the knowledge of specifically when they need to be back. This eliminates the uncertainty in the virtual queue length. As the reservation time is based on the number of patrons ahead of them at the time of reservation and the throughput of the attraction, this will also generally preserve the FIFO nature of the queue while freeing the patron to do something else while they are waiting to arrive at the front of the queue for the attraction.

A problem with this type of system, however, is that while the set return time allows the patron to do another activity while waiting, they will generally only do so if they know they can complete the other activity in time to get back in time for the reservation. Thus, the patron is likely to build in cushions around the return time resulting more waiting than may be necessary. A patron with a return time of 25 minutes may return 10 minutes early because they do not know the actual time needed to be back or may skip going to another attraction while waiting because they do not know if the secondary attraction will be done in time for them to get back. These problems are more acute during peak hours where queue length estimates and travel time may be changing rapidly.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein is a virtual queue system which utilizes a default FIFO system but can modify the FIFO nature of the system to allow for adjustment of place in line based on desire to experience a second attraction while in the virtual queue for the primary attraction. This will usually result in the generally voluntary acceptance of a later line position in exchange for knowledge that the waiting time is sufficient to experience the secondary attraction and to wait in any queue for the secondary attraction. The system generally serves to process patrons in an initially FIFO manner, but then allows them to move backward in line (allow future patrons to get ahead of them) in exchange for knowing that they can utilize another park attraction or resource while waiting and without losing their new position in line as the position can be specifically chosen to allow sufficient time to complete the secondary attraction.

There is described herein, in an embodiment, systems and methods for providing a virtual queue for an attraction, the systems and methods comprising: having a patron request a position in a virtual queue for a first attraction such as by using a device such as a computer kiosk or mobile device; a central controller or other device determining an initial position in the virtual queue for the first attraction to the patron; selecting a second attraction where there is insufficient time for the patron to travel to the second attraction, complete the second attraction, and return to the first attraction before the initial position would be at a head of the virtual queue for the first attraction; and providing an updated position in the virtual queue for the first attraction to the patron, where the updated position is behind the initial position and allows sufficient time for the patron to travel to the second attraction, complete the second attraction, and return to the first attraction before the updated position would be at the head of the virtual queue for the first attraction.

In an embodiment, the first attraction is an amusement park attraction.

In an embodiment, the second attraction is a food stand.

In an embodiment, the first attraction is a roller coaster.

In an embodiment, the second attraction is an amusement park attraction.

In an embodiment, the second attraction is a show.

In an embodiment, the patron performs the selecting.

In an embodiment, the systems and methods further comprise: providing an assigned position in a virtual queue for the second attraction to the patron.

In an embodiment, the systems and methods further comprise: selecting a third attraction where there is insufficient time for the patron to travel to the third attraction, complete the third attraction, and return to the second attraction before the assigned position would be at a head of the virtual queue for the second attraction; providing a new position in the virtual queue for the second attraction to the patron, where the new position is behind the assigned position and allows sufficient time for the patron to travel to the third attraction, complete the third attraction, and return to the second attraction before the new position would be at the head of the virtual queue for the second attraction; and providing a further updated position in the virtual queue for the first attraction to the patron, where the further updated position is behind the initial position and allows sufficient time for the patron to complete the second attraction when at the head of the virtual queue for the second attraction and then travel to the first attraction before the further updated position would be at a head of the virtual queue for the first attraction.

### BRIEF DESCRIPTION OF THE DRAWINGS

FIGS. 1A and 1B provide an embodiment of a mobile device app which allows for entry onto a virtual queue

FIG. 2 provides an embodiment of a paper ticket indicating entry into a virtual queue.

FIG. 3 provides an example of a screenshot showing queue management at a central authority.

### DESCRIPTION OF THE PREFERRED EMBODIMENT(S)

The following detailed description and disclosure illustrates by way of example and not by way of limitation. This description will clearly enable a person of ordinary skill in the art to make and use the disclosed system and method, and describes several embodiments, adaptations, variations, alternatives, and uses of the disclosed subject matter. As various changes could be made in the above construction without departing from the scope of the disclosure, it is intended that all matter contained in the description or shown in the accompanying drawings shall be interpreted as illustrative and not in a limiting sense.

It should be recognized that the disclosure herein is focused on queueing systems for amusement park rides and the like as the systems and methods discussed herein are particularly useful for an amusement park or similar entertainment venue which has a variety of unique attractions each of which will generally have a queue or other waiting period associated therewith. It is particularly valuable where the various attractions have large variances in both the wait time and the length of the attraction. Amusement parks and water parks are commonly arranged in this setup as it is not uncommon for a patron to wait in line an hour or more to ride on a ride that only lasts a couple of minutes while other rides may have no queues (zero waiting time) for a ride and shows may be based on fixed waiting times based on scheduled start times where the wait is more driven by individual patron behavior at a macro level than queue length.

For purposes of this disclosure, it should be recognized that any attraction or activity that people could line up or wait for, if there is more demand currently for the attraction than the attraction can accommodate, has a queue. This is true even if there are currently no people in the queue. In this situation, the queue wait time is simply zero (or very short). Thus, queues are not limited to attractions that actually have physical lines or to attractions which could have a line but do not because the queue has been made virtual. Further, this disclosure is not limited to queues for entertainment attractions, but can be used for any kind of queue foinied for any activity including, but not limited to, queues to purchase merchandise or services and queues to enter a facility.

Throughout this disclosure, the term “computer” describes hardware which generally implements functionality provided by digital computing technology, particularly computing functionality associated with microprocessors. The term “computer” is not intended to be limited to any specific type of computing device, but it is intended to be inclusive of all computational devices including, but not limited to: processing devices, microprocessors, personal computers, desktop computers, laptop computers, workstations, terminals, servers, clients, portable computers, handheld computers, cell phones, mobile phones, smart phones, tablet computers, server farms, hardware appliances, minicomputers, mainframe computers, video game consoles, handheld video game products, and wearable computing devices including but not limited to eyewear, wristwear, pendants, fabrics, and clip-on devices.

As used herein, a “computer” is necessarily an abstraction of the functionality provided by a single computer device outfitted with the hardware and accessories typical of computers in a particular role. By way of example and not limitation, the term “computer” in reference to a laptop computer would be understood by one of ordinary skill in the art to include the functionality provided by pointer-based input devices, such as a mouse or track pad, whereas the term “computer” used in reference to an enterprise-class server would be understood by one of ordinary skill in the art to include the functionality provided by redundant systems, such as RAID drives and dual power supplies.

It is also well known to those of ordinary skill in the art that the functionality of a single computer may be distributed across a number of individual machines. This distribution may be functional, as where specific machines perform specific tasks; or, balanced, as where each machine is capable of performing most or all functions of any other machine and is assigned tasks based on its available resources at a point in time. Thus, the term “computer” as used herein, can refer to a single, standalone, self-contained device or to a plurality of machines working together or independently, including without limitation: a network server farm, “cloud” computing system, software-as-a-service, or other distributed or collaborative computer networks.

Those of ordinary skill in the art also appreciate that some devices which are not conventionally thought of as “computers” nevertheless exhibit the characteristics of a “computer” in certain contexts. Where such a device is performing the functions of a “computer” as described herein, the term “computer” includes such devices to that extent. Devices of this type include but are not limited to: network hardware, print servers, file servers, NAS and SAN, load balancers, and any other hardware capable of interacting with the systems and methods described herein in the matter of a conventional “computer.”

For purposes of this disclosure, there will also be significant discussion of a special type of computer referred to as a “mobile communication device” or simply “mobile device”. A mobile device may be, but is not limited to, a smart phone, tablet PC, e-reader, satellite navigation system (“SatNav”), fitness device (e.g. a Fitbit™ or Jawbone™) or any other type of mobile computer whether of general or specific purpose functionality. Generally speaking, a mobile device is network-enabled and communicating with a server system providing services over a telecommunication or other infrastructure network. A mobile device is essentially a mobile computer, but one which is commonly not associated with any particular location, is also commonly carried on a user's person, and usually is in near-constant real-time communication with a network allowing access to the Internet.

As will be appreciated by one skilled in the art, some aspects of the present disclosure may be embodied as a system, method or process, or computer program product. Accordingly, these aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable media having computer readable program code embodied thereon.

Any combination of one or more computer readable media may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Throughout this disclosure, the term “software” refers to code objects, program logic, command structures, data structures and definitions, source code, executable and/or binary files, machine code, object code, compiled libraries, implementations, algorithms, libraries, or any instruction or set of instructions capable of being executed by a computer processor, or capable of being converted into a form capable of being executed by a computer processor, including without limitation virtual processors, or by the use of run-time environments, virtual machines, and/or interpreters. Those of ordinary skill in the art recognize that software can be wired or embedded into hardware, including without limitation onto a microchip, and still be considered “software” within the meaning of this disclosure. For purposes of this disclosure, software includes without limitation: instructions stored or storable in RAM, ROM, flash memory BIOS, CMOS, mother and daughter board circuitry, hardware controllers, USB controllers or hosts, peripheral devices and controllers, video cards, audio controllers, network cards, Bluetooth® and other wireless communication devices, virtual memory, storage devices and associated controllers, firmware, and device drivers. The systems and methods described here are contemplated to use computers and computer software typically stored in a computer- or machine-readable storage medium or memory. The term “app” may be used to generally refer to a particular software element, of any kind, which is designed specifically to run on a mobile communication device.

Throughout this disclosure, the term “network” generally refers to a voice, data, or other telecommunications network over which computers communicate with each other. The term “server” generally refers to a computer providing a service over a network, and a “client” generally refers to a computer accessing or using a service provided by a server over a network. Those having ordinary skill in the art will appreciate that the terms “server” and “client” may refer to hardware, software, and/or a combination of hardware and software, depending on context. Those having ordinary skill in the art will further appreciate that the tennis “server” and “client” may refer to endpoints of a network communication or network connection, including but not necessarily limited to a network socket connection. Those having ordinary skill in the art will further appreciate that a “server” may comprise a plurality of software and/or hardware servers delivering a service or set of services. Those having ordinary skill in the art will further appreciate that the term “host” may, in noun form, refer to an endpoint of a network communication or network (e.g., “a remote host”), or may, in verb form, refer to a server providing a service over a network (“hosts a website”), or an access point for a service over a network.

Throughout this disclosure, the terms “web,” “web site,” “web server,” “web client,” and “web browser” refer generally to computers programmed to communicate over a network using the Hypertext Transfer Protocol (“HTTP”), and/or similar and/or related protocols including but not limited to HTTP Secure (“HTTPS”) and Secure Hypertext Transfer Protocol (“SHTP”). A “web server” is a computer receiving and responding to HTTP requests, and a “web client” is a computer having a user agent sending and receiving responses to HTTP requests. The user agent is generally web browser software.

Throughout this disclosure, the term “real-time” refers to software operating within operational deadlines for a given event to commence or complete, or for a given module, software, or system to respond, and generally invokes that the response or performance time is, in ordinary user perception and considered the technological context, effectively generally cotemporaneous with a reference event. Those of ordinary skill in the art understand that “real-time” does not literally mean the system processes input and/or responds instantaneously, but rather that the system processes and/or responds rapidly enough that the processing or response time is within the general human perception of the passage of time in the operational context of the program. Those of ordinary skill in the art understand that, where the operational context is a graphical user interface, “real-time” normally implies a response time of no more than one second of actual time, with milliseconds or microseconds being preferable. However, those of ordinary skill in the art also understand that, under other operational contexts, a system operating in “real-time” may exhibit delays longer than one second, particularly where network operations are involved.

In order to best understand certain preferred embodiments of the present systems and methods, it is first desirable to provide a basic overview on the types of attractions and the related queues and waits that are common in many venues and specifically amusement parks. The first type of attraction are “rides”. Rides often only have a relatively short time spent interacting with the attraction (often only a couple of minutes) and riders usually have to be purposefully loaded into the ride. Waiting on a ride generally depends on the type of ride. Many amusement park rides are essentially arranged to be continuously serving patrons (continuous processing) where riders getting off the ride and riders getting on the ride is a near continuous process. Another way to think about this is that riders at the front of the queue are not waiting for the ride to end for people on the ride before they can get on. Basically, as they reach the front of the queue, they can load a ride vehicle in short order.

An example of a continuous processing ride is a roller coaster with multiple trains. Each train may carry a relatively small number of people, but some patrons are on the ride in one train while others are being off-loaded and a second group is loading into their train. Thus, the ride can provide for a very consistent throughput of patrons with a line that is essentially always moving. An extreme example would be a ride which has a number of vehicles which are continuously circling and each vehicle carries only a single passenger or very small group. In this type of ride, within an extremely short time window (e.g. seconds) for every person who gets off the ride, there is another person getting on. Rides with continuous throughput often have a wait that is much more dependent on queue length versus ride length.

Other types of rides utilize more of a batch processing scenario. In this arrangement, there is often only a single ride vehicle which can hold a large number of patrons. The vehicle is filled and the ride is run while the rest of the queue waits, when the ride is complete, the entire vehicle is emptied and another large batch is loaded. Patrons are seated together, and they then all experience the attraction simultaneously so the person at the very front of the queue and the last person that fits on the vehicle both have the same wait time while the ride runs. An example of this is a roller coaster with a single train running, but an easier example is a carousel where a relatively large number of patrons (e.g. 30 or 50) get on the ride at once, but the ride is relatively long and while it is occurring all patrons in the queue are not moving at all. In batch processing rides, the queue does not move as continuously and tends to move in waves. Further, the wait may be more dependent on the ride length than queue length unless the ride is particularly popular.

A third type of attraction are shows which place patrons in a theatre or similar venue. Show-type attractions are generally designed to handle very large batches of patrons, but provide a particularly long attraction often 15 or 30 minutes or more. To deal with the large batch and long attraction time, show attractions generally start and end at scheduled times. This allows for patrons to arrive at a venue at any time ahead of a specific show time slowly filling the venue. Everyone in the venue then experiences the attraction at the same time and they all leave together, with it often taking a relatively long time to empty the venue. Shows will usually have posted specific show times. These attractions often can handle a much larger number of patrons for each show (e.g. an amphitheater for such a show could hold hundreds or even thousands of patrons) but during the show the “line” for the next show is effectively not moving at all. It is important to recognize that show-type attractions may have a queue to enter the venue, but even if they do not, they generally require waiting “in line” by simply waiting due to going to the venue and finding a seat before the show starts. This waiting is still a FIFO line, but because many patrons experience the attraction simultaneously, the patrons experiencing the attraction simultaneously is generally much larger generally resulting in the entire line being admitted for each show.

A final form of attraction are those with uncontrolled throughput. An example of this is food or shopping attractions where a user may have no queue to experience certain parts of the attraction (e.g. browsing a store) but may have a wait that is very dependent on the actions of the other patrons, or themselves. For example, a food vendor with exactly the same number of people waiting in a queue may have the queue move very quickly if every patron is purchasing an easy to make and serve item and paying quickly, or a significant wait if patrons are purchasing long to assemble items and are paying slowly.

The present systems and methods, in an embodiment, provide for a virtual queue that is generally used to allow patrons in a more continuous flow attraction with a long queue to wait in a virtual queue for that attraction while simultaneously waiting for and experiencing a second attraction which will often be a more batch flow attraction (ride or show). It also allows, in an embodiment, them to self-schedule for an uncontrolled throughput attraction while waiting. The systems and methods do this providing the patron with an initial position in line based on the actual line length and attraction throughput, and then offering the patron the possibility of moving back in the queue to have a known sufficient time to experience a secondary attraction while waiting “in line” for the first

The virtual queue will generally operate as follows. When the patron wishes to join the virtual queue for a primary ride, they will indicate that they wish to enter the queue. This may be through a variety of sources such as by using a mobile device, via an automated kiosk, or by approaching an employee working with the queue. In an embodiment, the systems and methods may require the patron to be physically located near the attraction to join the queue, or they may be allowed to join from anywhere. Regardless of how they indicate their wish to enter the queue, the wish is transmitted to a central authority. The central authority will generally be a computer running software for queue management which is handling queues for multiple attractions in the venue.

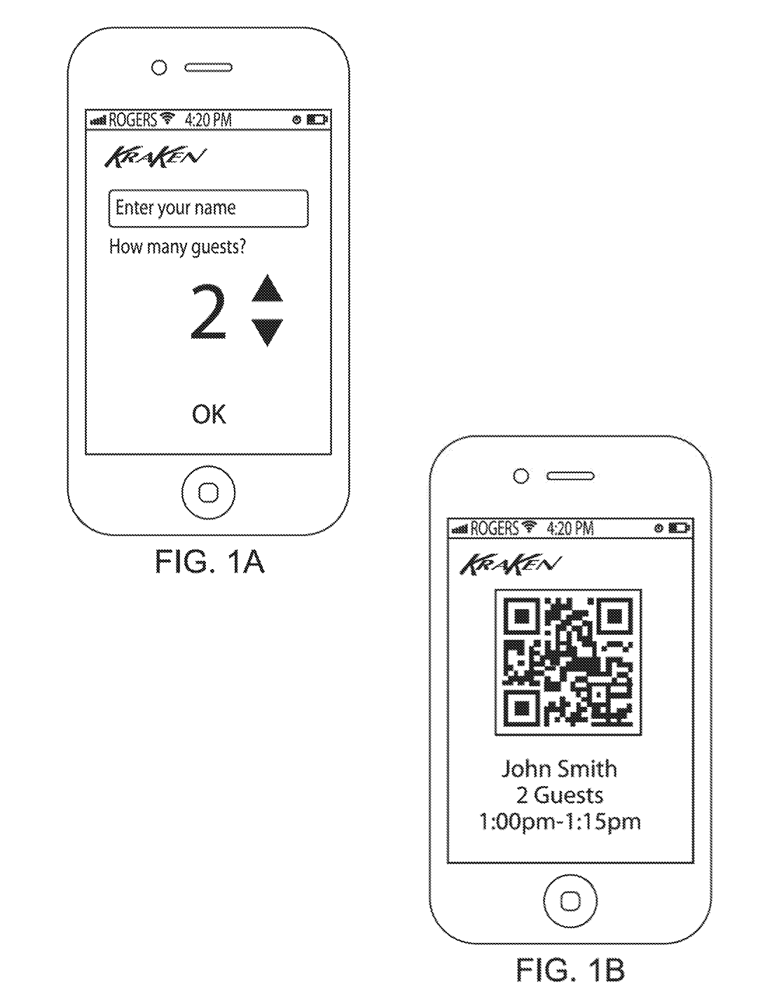

The central authority, upon receiving a request to enter a virtual queue for a particular attraction, will typically query for the size of the party which wishes to enter the queue together. This allows it to know the actual number of patrons entering the queue with this request. FIG. 1A shows an embodiment of a mobile device application (app) which has received such an inquiry. The patron will respond with an indication of how many in the current party will be joining the queue together which in the embodiment of FIG. 1A is two.

The number of patrons joining the queue will then generally be sent to the central authority and the queue position of the patrons will be processed. To assign a queue position, the central authority will commonly first look at the last previously assigned position in the virtual queue. The last position will commonly be either a wait time (e.g. 1 hour) or a fixed time or time window (e.g. 3:30-3:35 pm). The system will then look to see how many patrons are currently in line ahead of the current patron. This determination may be to the first patron in the current group, or the last. The central authority may choose to not count those that have either indicated that they are leaving the line (cancellations) or who have had their position in line arrive to the front, but were not available for the ride at that time (missed). Next, the central authority will determine the current throughput of the ride (e.g. the number of riders it can process within a certain time block). This may also be determined based on a planned throughput based on differing time blocks throughout the day, for example if additional ride vehicles will come into use as peak hours approach.

Using a process such as, but not limited to, an iterative loop, the central authority will then determine how long it takes to process all “in line” patrons ahead of the current patron based on filling the ride. The processing may take into account specific factors of groups and the ride interaction or other elements. For example, if the ride provides for a row of four patrons, the ride may round up groups of one or three patrons to the next even number on the assumption that there may not be an available rider to fill a single empty seat left open by these groups. Similarly, a large group which may fill multiple vehicles may be assumed to add additional processing time to get loaded. Further, if a ride vehicle is expected to be brought into service before the current queue is entirely processed, or if the ride needs to have a time period in which it is unavailable for service before the current queue can be processed, the central authority may factor in changes in throughput as these events occur.

The result of this determination is an indication of when the patron group currently inquiring to enter the queue would reach the front (head) of the queue if all patrons in the virtual queue were in front of them in a physical queue and actually stayed in the queue and experienced the attraction. This indication may be a specific time or a time block that the expected time falls within. That time is selected as the patron's proposed time slot for return. This proposed time will then be compared to the last previously assigned time. If it is equal to or later than the last previously assigned time, the user is assigned the proposed time slot as the return time, if the proposed time is before the last assigned time, the user will generally be assigned the last previously assigned time slot as their time. This serves to preserve the FIFO arrangement of the patrons as well as potentially building a small time cushion into the ride operation. It also allows for a large number of cancellations which may have occurred between the last two patrons requesting a position in line to be processed without placing a later requester in front of a prior one.

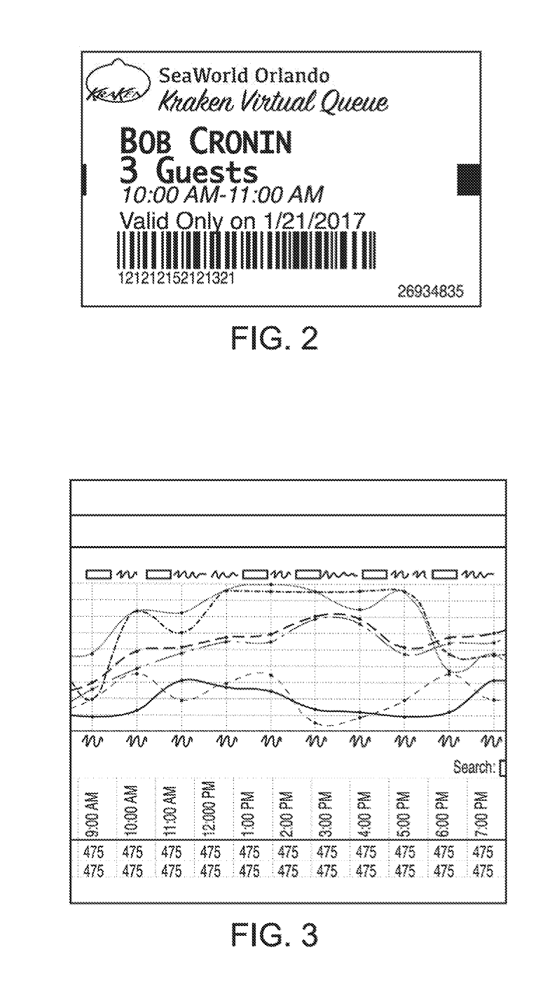

Once selected, the final return time slot is provided to the guest along with an identifier allowing them to identify themselves as the party to which that time slot belongs. In an app embodiment, the return may be to the mobile device indicating a computer readable code such as is shown in FIG. 1B. It may be done using a paper or other ticket as is shown in FIG. 2 or any other manner known to one of ordinary skill in the art. Regardless of the form in which it is provided, when the window arises, the patron will arrive at the attraction in the time slot where they will be identified as a patron with that slot, such as by scanning the computer readable code of FIG. 1B or collecting the paper ticket of FIG. 2, and the number of patrons allocated to that identifier will be allowed to enter the attraction. The patrons in the group will generally proceed immediately to the attraction to load into it. However, there may be a small physical queue after they have arrived and been processed. This allows for slight variation in arrival times, variations in vehicle load capacity, and other specifics of ride operation.

Based on the above, the virtual queue system operates in accordance with a standard FIFO line arrangement. That is, each person will always be behind (or equal to) any party that arrived ahead of them. The “equal-to” position is based on the fact that there may be a slight buffer built into the time slot to allow for a slightly inaccurate return by the patron, to deal with the fact that there can still be small batches of patrons necessary even in a near continuous operating attraction, and that most attractions have a batch greater than one per ride vehicle.

Should there be a problem with the attraction resulting in unexpected delay, the system will generally carry out a two stage accommodation. In the first instance, the system will immediately adjust the throughput of the attraction based on the expected downtime. This means that a patron entering the queue immediately after the attraction shuts down may have a much later return time as the throughput has gone down. This will commonly be done if the shutdown is expected to be of relatively small and known duration. In the event that a large percentage of the patrons in the virtual queue have network enabled devices, the central authority may actually adjust all the times for the patrons in the queue based on the expected downtime and may do so in real-time or near real-time as the downtime is known or estimated. This provides for a near real-time adjustment to the queue and allows patrons that have not yet arrived at the attraction, to know they do not need to return to the attraction yet.

In the second instance, should the downtime be of large estimated or very indeterminate size, the virtual queue may be dumped. In this case, patrons with network enabled devices may receive an indication that the queue has been dumped and all patrons have been removed. Once the downtime issue is resolved, the patrons that had been in the queue may then be invited to rejoin the queue if they are still interested in the attraction. This may be in the same order they originally were in the queue, or may be in any alternative order including all at once. Dumping the queue is undesirable, but it can be the most effective way to avoid having multiple patrons be upset when they return to find that the attraction is not available, and there is a large physical queue forming of indeterminate length.

Patrons with paper reservations as shown in FIG. 2 generally cannot be directly notified of the changes and have their return time changed. However, it is possible to have park messaging systems notify them and have them go to park personnel to receive an updated paper ticket regardless of where they are or when they return, they can be provided with an updated receipt that maintains their relative position in line, but adjusts the time for the downtime in the same way as a computer networked patron. In an embodiment, this may be accomplished whenever they seek out their next attraction queue position so that all their positions in all their virtual queues can be adjusted at any time a new one is requested.

While the above provides for a first aspect of a virtual line arrangement which eliminates the need for any physical queue that is being bypassed by the arriving patron and provides for systems that can dynamically adjust or dump the queue in the event of unexpected occurrences at the attraction, the present systems and methods provide for a further benefit where the position in the queue may be altered by the patron backward or forward based on the exercise of certain options. Generally, these will be backward movements to allow for the time that the person spends “in line” to be more useful to them by specifically gearing the wait time based on the availably of another attraction during the waiting time. As discussed previously, one of the problems with a reservation time system or prior virtual line systems is that the provided time may not allow enough time for the patron to actually do anything else while waiting. This can be particularly true if the alternative activity has a variable time to complete, or involves unknowns such as actual (as opposed to estimated) queue length, travel time to or from the attraction, or ride length.

In an amusement park embodiment, the uncertainties in queue length and attraction operation time can be great. For example, traditionally a ride which indicates that the queue is 15 minutes long, even in computer enabled systems, could actually have a much shorter, or substantially longer wait time. The reason for this is that the wait time calculation has traditionally been based on the time for a prior patron to complete the line. E.g. a first patron is timed from the time they enter the queue until they experience the attraction and spends 15 minutes in line. The wait time is commonly set as 15 minutes even though that was the wait time for a patron that has already completed the queue, not for one currently in the queue. This estimate can be wildly inaccurate as if the park became busier, and this ride more popular which this first patron was in line, the line behind this patron will commonly be longer than the line they experienced.

Another way in which wait times were typically calculated was to indicate a length of time based on the location of the last patron in line. This are often indicated by a sign that indicates “1 hour wait from here” or something similar. These systems, while simpler, can actually be more accurate. However, it is often not possible to know the length of the queue without actually being in it. Thus, a patron at a portion of the park remote from the attraction has no way of knowing the current queue length. These signs can also be wildly inaccurate as they simply take into account the main queue length. Events such as ride shutdowns, passengers requiring special accommodation, and the like can dramatically alter the time the queue takes to move.

These problems can be eliminated in various embodiments of the present system because the central authority, by essentially having control over the specific queues and, thus, access to very accurate and timely data on them, can determine any particular wait time at any particular instant based on the actual wait time they would assign to a patron requesting a position in that queue. Thus, when a patron requests entry in a first queue, the central authority could actually give them a position in any or all queues under the control of the central authority with a high degree of accuracy. However, the patron cannot simultaneously stand in all virtual queues as to do so would mean that they would reach the front of all of them simultaneously, and would only be able to experience the attraction where they physically were at the time they reached the head of the line.

In the present systems and methods, the patron is instead allowed to stand at different places in a variety of different virtual queues so that they reach the front of the queues in a sequential order and pattern that allows them to both wait in multiple queues simultaneously, and positions them within those queues so that they do not arrive at the head of the line at the same time in multiple lines. Instead, they arrive at the front of the queue in a pattern that relates to their travel time between attractions and proposed order of experiencing them.

In the simplest arrangement, the central authority allows for a user to move backward in a position in a primary virtual queue, in exchange for being placed in a second virtual queue which the patron will reach the front of, and experience the attraction, before their position in the primary queue is at the front. To do this the central authority can first determine an initial return time and can then determine if that time conflicts with the ability to utilize an alternative attraction while the patron is waiting and offer to move the patron backward in the virtual line to give the patron the ability to experience the alternative attraction while waiting.

Commonly, the alternative attraction will be a show or other attraction that utilizes much more batch processing than the primary attraction, but this is by no means required. The system typically alters the proposed return time moving the patron backward in the virtual line (behind patrons that have not yet requested entry into the virtual queue) to grant the patron the ability to have a waiting window that is known to be sufficient to experience the alternative attraction while waiting “in line” for the primary attraction.

The movement will typically be done transparently by expressly asking if the patron wishes to utilize the alternative attraction while waiting for the primary attraction in exchange for the later position in line, but may be done without their knowledge and at the dictate of the central authority in an opaque fashion. The later time is generally selected by the central authority to allow for the patron to have time to go through any queue (virtual or physical) associated with the attraction, experience the alternative attraction, and travel as necessary to and from the alternative attraction to the primary attraction. As the central authority is aware of not just the present queue time, but multiple attractions' queue times, show times, and relative travel times the central authority can make this calculation relatively easily.

The above concept of moving backward in the virtual line to experience the alternative attraction may be best illustrated by example. Let us presume a patron has indicated they wish to get in line for a roller coaster and requests being put in the line at 12:45 pm. Based on the present queue length (40 minutes), the return time assigned to this patron is 1:25-1:30. However, the amusement park also has a large show which has a scheduled time to run from 1:00-1:30 but is on the other side of the park (a 10 minute walk at a reasonable pace) from the roller coaster and the venue is only currently half full, and the park has a second ride, a haunted house, which is closer to the roller coaster and currently has a 15 minute line (which is short for that ride) but takes between 5 and 10 minutes to experience for the average patron and is 5 minutes from the patron's current location.

From the above, if the patron accepts the provided time, they cannot safely experience either the show or the haunted house while they are “in line” for the roller coaster. If they go to the show, they will arrive too late to the roller coaster to make their allowed window and they have no way of knowing they could go to the haunted house because they are not currently aware of its queue size (since it is geographically spaced from them even though it is closer). While the patron may see that the haunted house queue is short enough to experience before the roller coaster, they will generally only know this if they go to the roller coaster immediately, which they have no reason to do since they are not getting on the roller coaster for 40 minutes, and see the current haunted house line. Thus, the problem exists that assigning this patron this time makes it unlikely that the patron will fill the waiting time with another attraction (since these are the only attractions in this hypothetical).

Thus, should the patron take the offered time they may be idle until 1:25, effectively having the same effect as them being physically in line for the roller coaster with them simply not waiting in a physical line. In the present systems and methods, instead, the central authority recognizes the conflict and proposes to the user that they can either keep the 1:25-1:30 time place in line, or they can instead select a 1:45-1:50 time so that they can go to the show and still have time to walk from the show to the roller coaster to make their time.

Alternatively, the patron could be offered a 1:30-1:35 place in the roller coaster line in exchange for knowing that they can go to the haunted house, wait in the physical line there, and complete the haunted house attraction before getting on the roller coaster. If the patron wants to go to the show, they are likely to accept the later 1:45-1:50 position, and then go to the show comfortable in the knowledge that they can make both attractions. Similarly, they may accept the haunted house time position if they want to experience the haunted house, comfortable in the knowledge they can make both attractions. If they have no interest in either, or have already planned on doing something else (for example, getting a snack) they will keep their 1:25-1:30 time place in line and simply wait knowing they get on the roller coaster earlier.

The haunted house example above illustrates operation of another aspect of an embodiment of the system. As discussed above, the problem the patron has with going on the haunted house attraction while waiting in line for the roller coaster is that they have no way of knowing that this is feasible as they are unable to ascertain the actual length of the line for the haunted house from their current location. However, as the central authority can have control of both queues, the central authority does know the actual length of the line, and therefore can simply make this knowledge available to the user, even if them going on the haunted house attraction does not alter backward their position in the roller coaster virtual queue.

While the above provides for a very simple arrangement, it should be apparent that the central controller can get much more sophisticated on scheduling attractions. For example, in the above scenario, should the user wish to go to the haunted house, the central authority could actually place the user in a virtual line for the haunted house upon their selection of the haunted house giving them a 1:00 to 1:05 time to arrive at the haunted house (just the 15 minutes waiting time) allowing them to have a clear comfortable window to both walk to the haunted house and experience it, even if they wish to spend longer than the average patron, all while waiting in line for the roller coaster which they can essentially walk to after completing the haunted house and waiting for a relatively short time for their virtual line position to arrive. In an embodiment, the central controller could even indicate the expected time to actually wait in line after completing a first attraction and traveling to the next.

Also, while the above contemplates specifically assigning the patron a later time (move them back in line) it may actually give them the opportunity to stay in the same position while making them aware of the secondary opportunity (e.g. that they can go on the haunted house and still make the originally assigned time) or even to move up in line. While the latter may not be preferred as maintaining the FIFO nature of the line may be desirable, it should be recognized that for particularly popular attractions there may be a relatively large number of patrons asking to join the virtual queue near simultaneously. If a large number of these patrons select to move back to watch the show, those wanting to go to the haunted house may actually be moved forward in the virtual queue to make sure that the virtual queue does not experience a gap and to insure that the primary attraction is running at maximum capacity at all times.

It should further be apparent that the more attractions that have virtual queues controlled by the central controller and the more a patron is willing to simply experience any secondary attraction, the more the central controller can maximize their experience in the amusement park. In an embodiment, the central controller may actually plan out a large chunk of the patron's itinerary at the outset. For example, a patron upon arrival at the park may be requested to provide some basic information such as, but not limited to, how long they are planning to stay, which rides they really want to go on (e.g. a list of top 10 which could include riding a ride more than once), when and what they would like to eat, and any particular shows they would like to see. The central controller can then take this information and assign them a complete itinerary where they can be moved through rides, shows, and even food service and other activities throughout their stay experiencing all they wished to above, as well as a number of additional attractions, and do the entire process without ever having to wait in a significant line. This process can then be repeated for many or all of the patrons in the park.

Further, while the above contemplates a patron looking for a diverse park experience, the system could also readily cater to those of more specific interests. For example, if a patron was to arrive at the park and indicate that their goal was to ride the newest roller coaster as often as possible, the central controller could create an itinerary (knowing that the queue for that roller coaster was between 1 and 2 hours depending on the time of day) which allowed the user to effectively get in the roller coaster line at the start of the day and upon completion of that ride get back in line for it again and repeat this process the entire time they are at the park. This itinerary, however, could provide for each of those waiting blocks to be potentially filled with other rides or shows that this patron would typically never experience.

For the park owner, this type of arrangement provides a couple of clear advantages. In the first instance, a park designed according to utilize these systems and methods can have dramatically increased capacity without any physical alteration as the central controller can effectively provide patrons to rides so the rides are all running at close to maximum capacity at all times, show theatres are generally full, and food kitchens are preparing meals at their most efficient speed. The system also allows for rides which may have become less popular over time to regain patrons as these rides work well for patrons to ride while they are waiting in virtual queue for more popular rides. As the patrons know they can ride the specific rides they want to and the additional rides being offered are not stopping then from experiencing the primary rides they came for.

As part of the system, if the entire park queue system is controlled by a central controller it is possible for the itinerary of the patrons to actually be set based on estimated park attendance throughout the day and to alter over time to effectively eliminate any substantial waiting for the vast majority of patrons. For example, instead of the central controller providing the patron with an entire preset itinerary for the day, the itinerary may be provided in smaller blocks (for example, the next 1 or 2 hours) or may even be provided dynamically. In the later case, the central controller may provide updates as the patron works through the schedule. Thus, the patron could be told to go to a first ride and upon exiting the first ride, they are then told where to go next. This can itself provide for a patron experience of not knowing what is occurring next. It can also allow a patron the capability to alter their itinerary on the fly. Thus, if the patron got off the roller coaster and was suggested to go to a show, they could indicate that they were not interested in the show, and the system could respond with another ride noting that the show should not be suggested again. Similarly, if the patron needed to use the bathroom, that could be indicated and the next suggestion could only be made after they indicated they were ready for more rides. The key element of all these implementations is that as the patron arrives at the next attraction, they do not have to wait in any substantial queue and can get on the ride in a short period of time from their arrival, regardless of what ride it is, so long as it is the one suggested.

For families or groups with different tastes in rides (for example a dad who is looking to ride on thrill rides alone, but also wants to ride certain kids rides with his children) the system can also take this into account and suggest certain forms of rides which allow for the group to operate as a unit for a portion of the day, and to break up at other times of day to allow people within a group to do different things, as desired.

As should be clear, the patrons in the above embodiments have now filled a large amount of the idle time in the virtual line with a combination of travel time and a secondary attraction that they may not have otherwise been able to experience in the waiting time, or that they did not know they could experience in the waiting time. This has also been done without the need to provide the patron with any experience within the line for the roller coaster as the park's other attractions (as well as additional elements such as travel time) have been used to fill the idle time allowing the physical queue for the primary attraction to be much shorter, or potentially non-existent. This frees up space in the park for additional attractions.

While the initial example above was a simple example utilizing only three options for attractions, many amusement parks will have queue management software operating on the central authority or accessible by it over a network as indicated in FIG. 3 and the central authority can actually make proposed movements in the principle ride's proposed line position based on the current lines at all other attractions and expected throughput throughout the day. This may be by the central authority selecting proposed alternative attractions based on improving park throughput or flow, by expected desires of what the patron would be interested in experiencing as an alternative, or by improving the patrons' ability to experience a greater number of attractions during their visit. In an extreme implementation, it is possible to have the central authority monitor a virtual queue for every attraction in the park and allow all visitors to indicate their expected daily plans in advance. This would then allow the central authority to potentially allow patrons to experience a large number of attractions while waiting in only very small physical queues and the park to have very small queues at virtually all attractions, even at peak hours.

As should be apparent, the system is particularly valuable in an amusement park that has a large number of both large batch serving attractions (e.g. shows) and a large number of more continuous line attractions (rides) where certain attractions are likely to have very large lines, while others may have short or no lines. By providing the ability to adjust the place in a primary virtual line based on the desire to experience a secondary attraction while waiting, the patron can be directed to effectively spend the time in the virtual line watching a show or experiencing an attraction which already is at the park and may be otherwise underutilized. In a further example, the systems and methods could allow for the user to select a later time to allow them to do some shopping, play a game, or to have time to eat at a particular food vendor.

From a park management point of view, the systems and methods provide for two valuable elements. In the first instance, many show venues are not full at each show and there are often underutilized rides at particular times based simply on the ebb and flow of patrons. For example, ride lines may shorten around lunch time as many patrons are eating. Placing the patron in a show audience that was not full has no effect on the enjoyment of the show by other guests and provides this patron with additional experiences without loss to the park. Secondly, as the patron is spending the time “in line” at the show or at other attractions, time passes faster for them, and they will likely have a better experience at the park. It also means that there is a decreased need for the park management to have entertainment provided in a physical queue, as the entertainment is provided by other park attractions while the patron is “in line” allowing them to make the queue line structures physically smaller.

Park management also has a benefit from the ability to move the time based on allowing the patron to wait in line on currently underutilized attractions, increasing those attractions utilization. As contemplated above, the ability to move the position later in line (or even potentially forward) will generally come with a specific indication of what the patron can now complete while waiting which they may not have been able to do, or known they could do, before. Thus, the suggested attractions can be based on current utilization of attractions, as well as alternative items such as likelihood of the patron being interested in a particular type of attraction (they are primarily riding thrill rides), their proximity to an attraction (for instance if they request a position in line in a ride attraction while standing in front of a show time board for a particular show), or an external factor (water based or indoor rides and shows being suggested because the temperature is 95 degrees).

While the above specifically contemplates the idea of moving position in line based on other attractions, it should be readily apparent that other events also can be scheduled around in an embodiment of the systems and methods. For example, the user could be given the option of moving to a later time to give them the ability to have enough time to obtain and eat food from a nearby stand while waiting. In an embodiment, the general concept of “eating” could be suggested and if the patron is interested, the system could actually determine the expected amount of time to travel to, obtain food from, and eat at, a particular venue selected by the user from a list giving the user menu control and positioning them in line accordingly. Thus, a user can now spend the time “in line” eating the specific meal they select at the particular food location. The system could even suggest a later time to allow a user to shop, to play a game, or even to go to the restroom or change a baby if they indicated a desire to do those things.

In a still further embodiment, the systems and methods may not only suggest the user take a particular line position on the primary attraction, but could iteratively provide them with specific line positions from a variety of attractions at once or sequentially. Thus, a user may not only schedule a secondary attraction before the present one, but could select a third attraction with a place in line much moved back and temporally after they will have completed the primary attraction or to fill the line wait on both the primary and secondary attractions. This can assist the patron in not only believing that they can experience multiple of the most desirable attractions and plan their day, but can allow them to experience attractions they otherwise would have missed out on waiting in line.

Throughout this disclosure, relative terms such as “generally,” “about,” and “approximately” may be used, such as, but not necessarily limited to, with respect to shapes, sizes, dimensions, angles, and distances. One of ordinary skill will understand that, in the context of this disclosure, these terms are used to describe a recognizable attempt to conform a device to the qualified term. By way of example and not limitation, components such as surfaces described as being “generally planar” will be recognized by one of ordinary skill in the art to not be, in a strict geometric sense, planar, because in a real world manufactured item a surface is generally never truly planar as a “plane” is a purely geometric construct that does not actually exist, and no component is truly “planer” in the geometric sense. Thus, no two components of a real item are ever truly planar, as they exist outside of perfect mathematical representation. Variations from geometric descriptions are inescapable due to, among other things: manufacturing tolerances resulting in shape variations, defects, and imperfections; non-uniform thermal expansion; design and manufacturing limitations; and natural wear. There exists for every object a level of magnification at which geometric descriptors no longer apply due to the nature of matter. One of ordinary skill will understand how to apply relative terms such as “generally,” “about,” and “approximately” to describe a range of variations from the literal meaning of the qualified term in view of these and other considerations.

Further, use in this description of terms such as “upward” and “downward” do not actually require that certain surfaces or objects be closer or further away from a surface upon which an object is resting at any given time. Instead, they are generally used to denote opposite directions in conjunction with the standard arrangement of the FIGS. provided herein so as to give relative positioning of elements. Similarly, terms such as “forward” and “backward”, “left” and “right”, and “top” and “bottom” are used to show relative directions or positions as opposed to absolute location.

While the invention has been disclosed in conjunction with a description of certain embodiments, including those that are currently believed to be the preferred embodiments, the detailed description is intended to be merely illustrative and should not be understood to limit the scope of the present disclosure. As would be understood by one of ordinary skill in the art, embodiments other than those described in detail herein are encompassed by the present invention. Modifications and variations of the described embodiments may be made without departing from the spirit and scope of the invention.

1. A method for providing a virtual queue for an attraction, the method comprising:
having a patron request a position in a virtual queue for a first attraction;
determining an initial position in said virtual queue for said first attraction to said patron;
selecting a second attraction where there is insufficient time for said patron to travel to said second attraction, complete said second attraction, and return to said first attraction before said initial position would be at a head of said virtual queue for said first attraction; and
providing an updated position in said virtual queue for said first attraction to said patron, where said updated position is behind said initial position and allows sufficient time for said patron to travel to said second attraction, complete said second attraction, and return to said first attraction before said updated position would be at said head of said virtual queue for said first attraction.

2. The method of claim 1 wherein said first attraction is an amusement park attraction.

3. The method of claim 2 wherein said second attraction is a food stand.

4. The method of claim 3 wherein said first attraction is a roller coaster.

5. The method of claim 2 wherein said second attraction is an amusement park attraction.

6. The method of claim 5 wherein said first attraction is a roller coaster.

7. The method of claim 5 wherein said second attraction is a show.

8. The method of claim 1 wherein said patron performs said selecting.

9. The method of claim 1 further comprising:
providing an assigned position in a virtual queue for said second attraction to said patron.

10. The method of claim 9 further comprising:
selecting a third attraction where there is insufficient time for said patron to travel to said third attraction, complete said third attraction, and return to said second attraction before said assigned position would be at a head of said virtual queue for said second attraction;
providing a new position in said virtual queue for said second attraction to said patron, where said new position is behind said assigned position and allows sufficient time for said patron to travel to said third attraction, complete said third attraction, and return to said second attraction before said new position would be at said head of said virtual queue for said second attraction; and
providing a further updated position in said virtual queue for said first attraction to said patron, where said further updated position is behind said initial position and allows sufficient time for said patron to complete said second attraction when at said head of said virtual queue for said second attraction and then travel to said first attraction before said further updated position would be at a head of said virtual queue for said first attraction.

11. A system for providing a virtual queue for an attraction, the system comprising:
a device for a patron to request a position in a virtual queue for a first attraction;
a central controller:
receiving said request;
determining an initial position for said patron in said virtual queue for said first attraction;
calculating that there is insufficient time for said patron to travel to a second attraction, complete said second attraction, and return to said first attraction before said initial position would be at a head of said virtual queue for said first attraction; and
providing to said device an updated position to said patron in said virtual queue for said first attraction, where said updated position is behind said initial position and allows sufficient time for said patron to travel to said second attraction, complete said second attraction, and return to said first attraction before said updated position would be at said head of said virtual queue for said first attraction.

12. The system of claim 11 wherein said first attraction is an amusement park attraction.

13. The system of claim 12 wherein said second attraction is a food stand.

14. The system of claim 12 wherein said second attraction is an amusement park attraction.

15. The system of claim 14 wherein said second attraction is a show.

16. The system of claim 11 wherein said patron utilizes said device to select said second attraction and said device transmits said selection to said central controller.

17. The system of claim 11 wherein said device is a computer kiosk.

18. The system of claim 11 wherein said device is a mobile device.

19. The system of claim 11 further comprising:
said central controller providing an assigned position in a virtual queue for said second attraction to said device.

20. The system of claim 19 further comprising:
said central controller:
selecting a third attraction where there is insufficient time for said patron to travel to said third attraction, complete said third attraction, and return to said second attraction before said assigned position would be at a head of said virtual queue for said second attraction;
providing a new position in said virtual queue for said second attraction to said device, where said new position is behind said assigned position and allows sufficient time for said patron to travel to said third attraction, complete said third attraction, and return to said second attraction before said new position would be at said head of said virtual queue for said second attraction; and
providing a further updated position in said virtual queue for said first attraction to said device, where said further updated position is behind said initial position and allows sufficient time for said patron to complete said second attraction when at said head of said virtual queue for said second attraction and then travel to said first attraction before said further updated position would be at a head of said virtual queue for said first attraction.
